(19) United States
(12) Patent Application Publication
(10) Pub. No.: US 2011/0281047 A1
(43) Pub. Date: Nov. 17, 2011

(54) SELF-MATING ADHESIVES FOR AEROSTATS

(75) Inventors: Paul A. Ansolabehere, Minnetonka, MN (US); Dean S. Borchardt, River Falls, WI (US); Todd R. Sarnstrom, SR., Ellsworth, WI (US)

(73) Assignee: Anagram International, Inc., Eden Prairie, MN (US)

(21) Appl. No.: 13/106,458

(22) Filed: May 12, 2011

Related U.S. Application Data
(60) Provisional application No. 61/345,238, filed on May 17, 2010.

(51) Int. Cl. B29D 22/02; B32B 38/04

(52) U.S. Cl. 428/35.4; 156/182

(57) ABSTRACT

A method of constructing an aerostat involves using a self-mating adhesive system to bind a first barrier film and a second barrier film together. The adhesive precursors of the self-mating adhesive system are applied to the first and second barrier films at the desired point of bonding between the films. Following the application of the adhesive precursors, the barrier films are pressed together to bring the adhesive precursors into contact with each other. A self-mating adhesive layer, which binds the first and second barrier films together, is formed as a result of the reaction between the adhesive precursors. Thereafter the aerostat is die cut out of the web film. The method of the present invention results in aerostats with a bond line at the edge of the desired shape. These aerostats have a reduced weight compared to aerostats made using conventional practices employing a heat sealing layer.

### CROSS-REFERENCE TO RELATED APPLICATION

This application claims the benefit of U.S. Provisional Application No. 61/345,238, filed May 17, 2010, which is incorporated herein by reference in its entirety.

### TECHNICAL FIELD

The present invention relates to an aerostat, such as a novelty balloon, utilizing a self-mating two-part adhesive system as a bonding mechanism to enclose lighter than air gases between two or more barrier films.

### BACKGROUND OF THE INVENTION

Aerostats are objects using principles of aerostatics to float, i.e. lighter than air objects, such as balloons, that derive their lift from the buoyancy of surrounding air rather than from aerodynamic motion. According to Archimedes' Principle, an object is buoyed up by a force equal to the weight of the fluid displaced by the object. For an aerostat, the buoyant force must be sufficient to overcome the total weight of the aerostat in order to float.

Aerostats generally consist of a relatively thin film material creating a volumetric body that contains a lighter than air gas to create buoyancy. Aerostats commonly employ helium as a lighter than air gas.

Novelty balloons are an example of aerostats that utilize thin polymeric films to create a volumetric body suitable for containing a lighter than air gas. The films are generally constructed to have a gas barrier layer on a carrier substrate and a sealant layer. The multilayered films are manufactured in a web format with conventional converting practices. The sealant layer enables the combination of two separate films to create a volumetric body by heat sealing the two films into a desired pattern. The polymeric films are optionally printed with fanciful art or greetings, prior to being mated with a second polymeric film. The two films are then heat sealed together and the article is cut along a periphery of the sealed area to create the article.

In order to enable the broad production of numerous designs and shapes on one mass produced polymeric film, the sealant layer is coated onto the polymeric film in both the crossweb and downweb direction. As a result, the articles created by the combination of the two polymeric films possess a sealant layer across the entirety of the article, with heat activated seals about its periphery. The conventional practice of employing heat sealing layers on aerostats results in undesirable weight that can adversely impact the lifting capacity and ultimately limit the physical size of the aerostat.

### SUMMARY OF THE INVENTION

The present invention is directed to a method of constructing an aerostat which involves using a self-mating two-part adhesive system to bind a first barrier film and a second barrier film together. The parts of the two-part adhesive system are applied to the first and second barrier films at the desired point of bonding between the films. This practice eliminates the need to utilize a heat sealant layer across the entirety of the film, which results in a cost savings. Moreover, the reduction of overall weight of the aerostat results in a corresponding increase in lifting capacity necessary for the aerostat to remain aloft. The reduced weight, in comparison to aerostats constructed via conventional practices employing a heat sealing layer, enables the construction of smaller volume aerostats, as well as aerostats with intricate designs.

The method of applying the parts of the self-mating two-part adhesive system at the desired point of bonding can be accomplished by coating techniques such as flexographic printing, inkjet printing, roll transfer, or silk screening techniques. The parts of the self-mating two-part adhesive system include a first adhesive precursor and a second adhesive precursor. The first adhesive precursor is applied to the inner side of the first barrier film, and the second adhesive precursor is applied to the inner side of the second barrier film. The adhesive precursors are applied about the periphery of the final design of the aerostat. Desired art or graphics may optionally be printed on the outer side of either, or both, of the first and second barrier films prior to the application of the adhesive precursors. After the adhesive precursors are applied to the first and second barrier films, the barrier films are pressed together to bring the first and second adhesive precursors into contact with each other. A self-mating adhesive layer, which binds the first and second barrier films together, is formed as a result of the reaction between the first adhesive precursor and the second adhesive precursor. Thereafter the aerostat is die cut out of the web film. The method of the present invention results in aerostats with a bond line at the edge of the desired shape.

The present invention is also directed to an aerostat in which the bond between the barrier films is imparted by a self-mating adhesive layer. The use of an adhesive layer at the desired point of bonding enables the formation of aerostats with dimensionally smaller structures than those enabled by constructions employing a heat sealing layer. This is primarily due to the reduction in mass due to the elimination of a sealant layer. At least one embodiment of the present invention permits the formation of an aerostat having an internal volume of less than about 2000 cm³. That volume is significantly lower than the volume of aerostats that are limited through the production of heat sealant layers.

In another embodiment, adhesive precursors suitable for application at the point of bonding provide greater control in applying a minimal amount of adhesive precursors yet attaining preferred bond strength. The greater control provides the ability to create a greater variation in shapes for the end use article, and enables the construction of aerostats with intricate designs. Additionally, in some embodiments, the self-mating adhesive layers provide consistent, uninterrupted bonds. This is important to prevent leakage of the lighter than air gas.

An object of the present invention is to provide low volume aerostats that are able to remain aloft.

Another object of the present invention is to provide aerostats in a wide variety of shapes, including aerostats having intricate designs.

A further object of the present invention is to produce aerostats at a lower cost than aerostats constructed using heat sealing layers.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF DRAWINGS

FIG. 1 is a schematic of one process suitable for practicing the present invention.

FIG. 2 is a perspective view of an embodiment of an assembled aerostat made in accordance with the present invention.

### DETAILED DESCRIPTION OF THE INVENTION

The present invention is directed to an aerostat including a first barrier film having a first film inner side and a first film outer side, and a second barrier film having a second film inner side a second film outer side. The first barrier film and the second barrier film are bonded together by a self-mating adhesive layer. This self-mating adhesive layer is formed by a reaction between a first adhesive precursor printed on the first film inner side, and a second adhesive precursor printed on the second film inner side. For example, the first adhesive precursor may include a resin, such as an epoxide resin, and the second adhesive precursor may include a curing agent. Examples of possible epoxide resins include, but are not limited to, bisphenol A diglycidyl ether, tetraglycidyl methylene dianiline (TGMDA), and cycloaliphatic epoxies. Examples of possible curing agents that may be used include, but are not limited to, polyamine hardeners such as diethylene triamine (DETA), triethylene tetramine (TETA), and hexamethylene tetramine.

When an epoxide resin is used as the first adhesive precursor, and a polyamine hardener is used as the second adhesive precursor, the self-mating adhesive layer resulting from the reaction between the first adhesive precursor and the second adhesive precursor will comprise an epoxy adhesive. Depending on the adhesive precursors used, self-mating adhesive layers in accordance with the present invention may also include adhesives such as, but not limited to, polyester adhesives, polyimide adhesives, polyamide adhesives, polyurethane adhesives, and silicone adhesives.

The present invention is also directed to a method of making an aerostat from a continuous web. This method includes unwinding a first and second barrier film, each film having an inner side and an outer side, from continuous rolls. A first adhesive precursor is printed on the inner side of the first barrier film, and a second adhesive precursor is printed on the inner side of the second barrier film. The barrier films are then laminated together such that at least a portion of the first adhesive precursor is in contact with at least a portion of the second adhesive precursor. The barrier films are subsequently die cut to form an outer edge of the aerostat, and the aerostat is removed from the continuous web.

In some embodiments, the self-mating adhesive layer is formed by bringing the first adhesive precursor into contact with the second adhesive precursor. In other embodiments, after the laminating step, the barrier films and adhesive precursors are irradiated with radiation such as thermal, actinic, ultraviolet, or electron beam radiation, in order to cure the adhesive and form the self-mating adhesive layer.

Materials and methods which may be utilized in accordance with the present invention are further discussed below.

Those of ordinary skill in the art of manufacturing aerostats, such as novelty balloons, recognize that barrier films are necessary to prevent the depletion of a lighter than air gas from aerostats. For purposes of the invention, a barrier film may possess an oxygen gas transmission rate of less than 0.15 cc/100 sq. in./day. The barrier films suitable for use in this application may include, for example, those disclosed in U.S. Pat. No. 7,799,399 and U.S. Patent Application Publication No. 2009/0022919, herein incorporated by reference in their entirety.

In one embodiment, the barrier film may be a polyamide, a polyester or a polyolefin based polymer, or combinations of such polymers. For example, a barrier film may be a lamination of a polyester film that includes a biaxially oriented polyester core layer and an amorphous copolyester skin layer. The barrier film may be clear or opaque, or it may be coated with an additional layer, such as a light reflecting layer.

Non-limiting examples of polyamide barrier films useful in this invention include nylon 4, nylon 4.6, nylon 6, nylon 6.6, nylon 6.10, nylon 6.12, nylon 11 and nylon 12.

In another embodiment, the barrier film may be a high crystalline polyester film achieved by bi-axial orientation. This crystallized portion of the film may contribute to making the film stiff and tear resistant during the balloon fabrication process, while remaining thin enough to make the balloon light.

Suitable polyesters may be a polymer obtained by polycondensation of a diol and a dicarboxylic acid. The dicarboxylic acids may include, for example, terephthalic acid, isophthalic acid, phthalic acid, naphthalenedicarboxylic acid, adipic acid and sebacic acid, and the diols may include, for example, ethylene glycol, trimethylene glycol, tetramethylene glycol and cyclohexane dimethanol. The polyesters may include, for example, polymethylene terephthalate, polyethylene terephthalate, polypropylene terephthalate, polyethylene isophthalate, polytetramethylene terephthalate, polyethylene-p-oxybenzoate, poly-1,4-cyclohexylenedimethylene terephthalate and polyethylene-2,6-naphthalate.

These polyesters may be homopolymers or copolymers, and the co-monomers may include, for example, diols such as diethylene glycol, neopentyl glycol and polyalkylene glycols, dicarboxylic acids such as adipic acid, sebacic acid, phthalic acid, isophthalic acid and 2,6-naphthalenedicarboxylic acid, and hydroxycarboxylic acids such as hydroxybenzoic acid and 6-hydroxy-2-naphthoic acid.

Polyethylene terephthalate and polyethylene naphthalate (polyethylene-2,6-naphthalate) may be used to achieve higher crystallinity. Further, the polyester may include various types of additives such as, for example, an antioxidant, a heat-resistant stabilizer, a weather-resistant stabilizer, an ultraviolet ray absorber, an organic slipperiness imparting agent, a pigment, a dye, organic or inorganic fine particles, a filler, an antistatic agent, a nucleating agent and the like.

In certain embodiments, multiple layer barrier films may be utilized. Multiple layer films may include coextruded layers with at least one layer being an amorphous polymer. Those of ordinary skill in the art are capable of selecting polymeric compositions for multiple layer applications to achieve specific barrier properties.

Non-limiting examples of polyolefin barrier films useful in this invention include biaxially oriented polypropylene and high density polyethylene.

The barrier layer may also include a metalized or ceramic layer bonded to a polyamide, polyester or polyolefin substrate. For example, a metalized layer such as aluminum, or a ceramic deposition layer such as SiOx and AlOx, may be suitable for use with the present invention. The metalizing layer or ceramic deposition layer may be applied using any available deposition method such as physical vapor deposition or chemical vapor deposition. The metalizing layer may be deposited to a thickness of greater than 20 nanometers. Those of ordinary skill in the art of vapor deposition are capable of selecting an appropriate composition and technique to create a suitable barrier layer for the present invention.

Suitable barrier films may generally include, but are not limited to, olefin-based films, polyester, nylon, polypropylene, biodegradable polylactic acid (PLA) and the like, as well as bio-based polymer polyhydroxy butyrate-valerate (PHBV).

Biodegradable films may also be utilized in this invention. Biodegradable films are comprised of one or more biodegradable polymers. Biodegradable films of this invention are produced by melt processing biodegradable polymers into thin films. This can be done using conventional melt processing techniques useful for producing thin films. Non-limiting examples of melt processing techniques useful for producing films include cast and blown film extrusion.

The biodegradable polymers may include those polymers generally recognized by those of ordinary skill in the art to decompose into compounds having lower molecular weights. Non-limiting examples of biodegradable polymers suitable for practicing the present invention include polysaccharides, peptides, aliphatic polyesters, polyamino acids, polyvinyl alcohol, polyamides, polyalkylene glycols, and copolymers thereof.

In one aspect of the present invention, the biodegradable polymer is a linear polyester. Non-limiting examples of linear polyesters include polylactic acids, poly-L-lactic acid (PLA), and a random copolymer of L-lactic acid and D-lactic acid, and derivatives thereof. Other non-limiting examples of polyesters include polycaprolactone, polyhydroxybutyric acid, polyhydroxyvaleric acid, polyethylene succinate, polybutylene succinate, polybutylene adipate, polymalic acid, polyglycolic acid, polysuccinate, polyoxalate, polybutylene diglycolate, and polydioxanone.

The thickness of the barrier film may range up to about 50 micrometers, suitably 0.18 to 2 mils and ideally 0.36 to 0.48 mils. The materials of construction for the barrier layer, the thickness of the materials employed, and the desired shape of the article should be selected by one of ordinary skill in the art to achieve a desired float time for the aerostat.

The aerostat, and in particular balloons for novelty applications, may optionally include aesthetic layer(s), such as graphics, indicia, print, fanciful art, or alphanumeric characters applied onto an exposed surface of the article. Flexographic printing is one means for applying such an aesthetic layer or layers. The printing equipment used in this process may be set up in a manner that will prevent scratching, scuffing or abrading of the gas barrier surface.

Various adhesives may be applied onto an edge of the barrier films to form a bond between the barrier films. The adhesive thicknesses may range up to about 2.5 mils, and preferably range from about 0.75 to 1.25 mils. In some embodiments, the seal width, as determined by the application of the adhesive, is about 1/32 of an inch, and more preferably 1/16 of an inch and even more preferably ⅛ of an inch.

The present invention involves the use of self-mating adhesives that are useful as a sealant for specialty films, including aerostats and decorative balloons. The self-mating adhesives are formed by printing cross-reactive chemicals onto two film webs, registering the webs, and laminating the webs together. The lamination step brings the cross-reactive chemicals into intimate contact to form the aerostat sealant. A subsequent curing step, utilizing radiation such as thermal or actinic radiation, is optionally utilized to finish the aerostat sealant layer. For example, a first adhesive precursor comprising the first part of a two-part adhesive system may be printed on a first barrier film, and a second adhesive precursor comprising the second part of the two-part adhesive system may be printed on a second barrier film. The first and second adhesive precursors react with each other upon registration and lamination of the barrier films.

Any cross-reactive polymerization strategies can be employed to form a self-mating adhesive system. Non-limiting examples of useful polymerization reactions include condensation polymerization, cationic polymerization, anionic polymerization, and free radical polymerization. Suitable condensation type polymerizations may involve two-part adhesive systems which form epoxies, polyesters, polyimides, polyamides, polyurethanes, and/or silicones. Free radical, cationic, or anionic polymerization methods may also be employed to form the self-mating adhesive layer of this invention. In one embodiment, one of the film webs is coated with a monomer while the other film web is coated with a catalyst. Upon subsequent registration and lamination of the webs, the catalyst enables rapid polymerization of the monomer to produce the aerostat sealant. Optionally, radiation such as thermal, actinic, ultraviolet, or electron beam radiation can be utilized in these methods to further enhance polymerization and cross-linking of the sealant chemicals.

In one embodiment, the self-mating adhesives of this invention exhibit pressure sensitive characteristics. Pressure sensitive adhesive (PSA) compositions are well known to those skilled in the art to possess properties that include: (a) aggressive and permanent tack; (b) adherence with no more than finger pressure; (c) sufficient ability to hold onto an adherent; and (d) sufficient cohesive strength. Certain PSA's can also be removed cleanly from their original target substrate. Materials that have been found to function well as PSA's include polymers designed and formulated to exhibit the requisite viscoelastic properties resulting in a desired balance of tack, peel adhesion and shear holding power. In some embodiments of this invention, the pressure sensitive adhesive provides a permanent bond to seal two barrier films and form the aerostat. Those skilled in the art will recognize the types and amounts of monomers, cross-linking agents, initiators and additives required to form a self-mating adhesive having pressure sensitive adhesive properties.

In another embodiment, the self-mating adhesives of this invention exhibit structural adhesive characteristics. Structural adhesives are well known to those skilled in the art to possess properties that include aggressive and permanent adhesive bonds. In one embodiment, the structural adhesive bond is greater than the tensile strength of the aerostat film. In this instance, the film will fail before the adhesive bond fails. Non-limiting examples of suitable structural adhesives include: epoxies, polyurethanes, polyesters, polyamides, polyimides, and silicones. Those skilled in the art will recognize the types and amounts of monomers, cross-linking agents, initiators and additives required to form a self-mating adhesive having structural properties.

In another embodiment, the self-mating adhesive of this invention is an elastomeric sealant. The sealant must have bond and sealant strength such that it functions in the aerostat. Non-limiting examples of suitable elastomeric sealants include silicones, polyisobutylenes, polyacrylates, epoxies, and polyurethanes. Those skilled in the art will recognize the types and amounts of monomers, cross-linking agents, initiators and additives required to form a self-mating adhesive having elastomeric sealant properties.

An optional valve for the insertion of the lighter than air gas is commonly placed between the first barrier film and the second barrier film. Conventionally recognized valves suitable for the insertion of a lighter than air gas may be employed in conjunction with the aerostat. For example, self-sealing, flexible valves such as those described in U.S. Pat. No. 4,917,646 and U.S. patent application Ser. No. 12/079,799 filed Mar. 28, 2008, both for balloon valves and herein incorporated by reference in their entirety, may be utilized. Those of ordinary skill in the art are capable of selecting a particular valve depending upon the desired application.

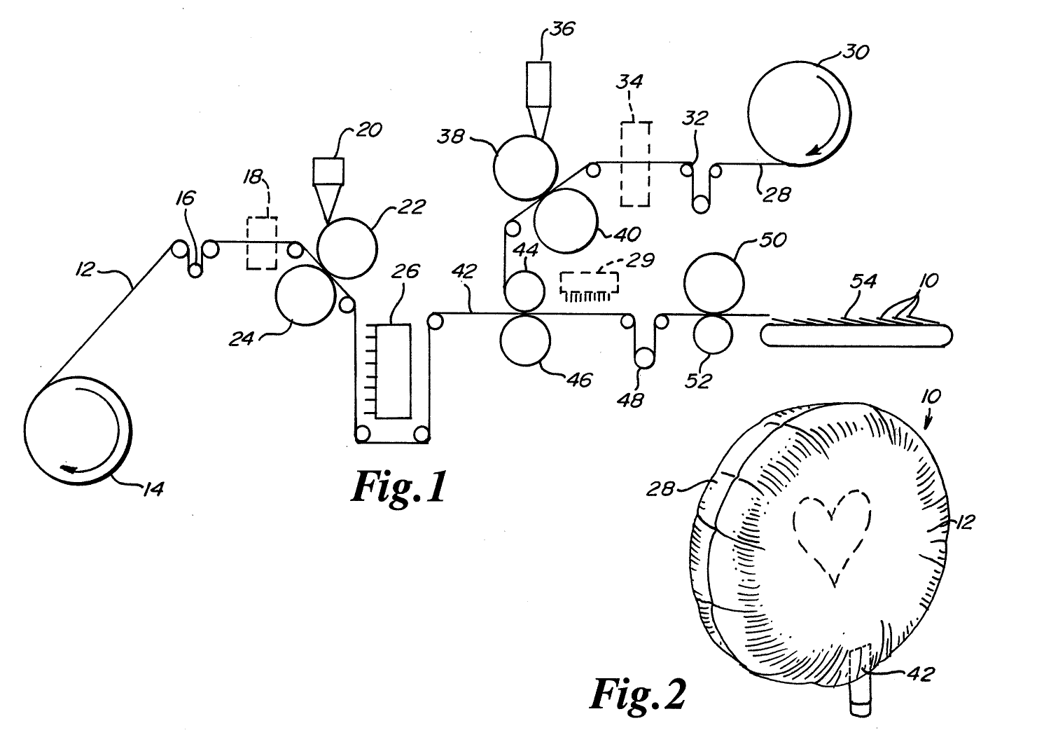

FIG. 1. depicts one method of the present invention suitable for making balloons, such as the balloon 10 shown in FIG. 2, from two separate barrier films. A first barrier film 12 is placed on an unwinding station 14. After the first barrier film 12 is unwound from a roll at unwinding station 14, the barrier film 12 is conveyed through a registration station 16, where tension is applied to the barrier film 12, and the barrier film 12 is aligned. The barrier film 12 then passes through an optional printing station 18 to apply a desired aesthetic design. A first adhesive precursor, dispensed from a precursor dispenser 20, is then printed onto the inner side of barrier film 12 through a print roller 22 and impression roller 24. The first adhesive precursor may or may not be irradiated. If it is irradiated, the first adhesive precursor may be irradiated at curing station 26 prior to coming into contact with a second barrier film 28. Alternatively, curing may take place after lamination at curing station 29.

Concurrently, the second barrier film 28 is conveyed from unwinding station 30 through a registration station 32 and an optional printing station 34. The second adhesive precursor, which is dispensed from the precursor dispenser 36, is then printed onto the inner side of the second barrier film 28 through a print roller 38 and impression roller 40. The second adhesive precursor may or may not be irradiated. A valve 42 is then applied onto film 12 so that it will be affixed between barrier films 12 and 28.

The first barrier film 12 and the second barrier film 28 are then conveyed through a laminating station with nip roller 44 and compression roller 46 to form a bond between films 12 and 28. The films 12, 28 are subsequently conveyed through registration station 48. The aerostat design is then die cut at die cutting roller station 50 and compression roller 52. Finished aerostats 10 are removed from the laminated films 12, 28 by conventional pick and place equipment (not shown) at finished product station 54 to create an uninflated aerostat or balloon 10.

The balloon 10 in an inflated form is shown in FIG. 2. The balloon 10 includes films 12 and 28, which are bonded together by a self-mating adhesive layer. Balloon 10 also includes a valve 42.

In certain embodiments, the aerostats may have an oxygen transmission rate of less than 0.15 cc/100 sq. in./day, a sealing strength of the seam on the aerostat of greater than 2000 g/in, and a floating time of the article in air at standard sea level conditions of greater than 48 hours. Additionally, certain embodiments may result in relatively small volumetric designs such as aerostats having an internal volume of less than about 2000 cm³.

Oxygen transmission rates are measured using a MOCON Ox-Tran L series device utilizing ASTM D3985 with test conditions of 73° F. and 0% RH at 1 ATM.

Seal strength is tested using a modified ASTM F88 test standard. The sealed materials are cut so that each web can be gripped in a separate jaw of the tensile tester and a 1 inch×⅜ inch section of sealed material can be peeled apart on an Instron tensile tester in an unsupported 90° configuration. Initial grip separation is at 4 inches with a preload rate of 2 in/min until 0.5 lbs of resistance is reached. Tensile force is continued at a rate of 6 in/min until the load drops by 20% of the maximum load, signaling failure. The maximum recorded load prior to failure is reported as the seal strength.

The floating time of the aerostat is determined by inflating the aerostat with helium gas and measuring the amount of time that the aerostat remains fully inflated. An aerostat is filled from a helium source using a pressure regulated nozzle designed for “foil” balloons, such as the Conwin Precision Plus balloon inflation regulator and nozzle. The pressure is regulated to 16 inches of water column pressure with an automatic shut-off. The aerostat is filled with helium in ambient conditions, at a temperature of about 70° F., until the internal pressure of the aerostat reaches 16 inches of water column and the regulator shuts off. The aerostat should be tethered below the aerostat's valve access hole to avoid distorting or damaging the valve, which may cause slow leaks of helium gas through the valve. During the testing the aerostat should be kept in a stable environment close to the ambient conditions stated. Changes in temperature and barometric pressure should be recorded to interpret float time results, as any major fluctuations can invalidate the test. The aerostat is observed over the course of the test for the appearance of fullness. The aerostat begins to lose the appearance of fullness when the appearance of the aerostat changes so that the wrinkles become deeper and longer, extending into the front face of the aerostat, and when the cross-section of a seam becomes a v-shape, as opposed to the rounded shape that characterizes a fully inflated aerostat. At this time the aerostat will still physically float, but will no longer have an aesthetically pleasing appearance. The number of days between initial inflation and the loss of aesthetic appearance described above is reported as the floating time of the aerostat.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An aerostat comprising:
(a) a first barrier film having a first film inner side and a first film outer side;
(b) a second barrier film having a second film inner side and a second film outer side; and
(c) a self-mating adhesive layer binding the first barrier film to the second barrier film.

2. The aerostat of claim 1, wherein the self-mating adhesive layer is formed by a reaction between a first adhesive precursor printed on the first film inner side and a second adhesive precursor printed on the second film inner side.

3. The aerostat of claim 2, wherein the first adhesive precursor comprises a resin and the second adhesive precursor comprises a curing agent.

4. The aerostat of claim 3, wherein the resin is an epoxide resin.

5. The aerostat of claim 2, wherein the first adhesive precursor comprises a monomer and the second adhesive precursor comprises a catalyst.

6. The aerostat of claim 1 wherein the self-mating adhesive layer comprises an adhesive selected from the group consisting of epoxy, polyester adhesives, polyimide adhesives, polyamide adhesives, polyurethane adhesives, and silicone adhesives.

7. The aerostat of claim 1 wherein the aerostat has an internal volume of less than about 2000 cubic centimeters.

8. The aerostat of claim 1 wherein the self-mating adhesive layer has a seal strength of greater than about 2000 grams per inch.

9. An aerostat comprising:
(a) a first barrier film having a first film inner side and a first film outer side;
(b) a second barrier film having a second film inner side a second film outer side; and
(c) a self-mating adhesive layer binding the first barrier film to the second barrier film, wherein the self-mating adhesive layer is formed by a reaction between a first adhesive precursor printed on the first film inner side and a second adhesive precursor printed on the second film inner side.

10. The aerostat of claim 9, wherein the first adhesive precursor comprises a resin and the second adhesive precursor comprises a curing agent.

11. The aerostat of claim 10, wherein the resin is an epoxide resin.

12. The aerostat of claim 9, wherein the first adhesive precursor comprises a monomer and the second adhesive precursor comprises a catalyst.

13. The aerostat of claim 9 wherein the self-mating adhesive layer comprises an adhesive selected from the group consisting of epoxy, polyester adhesives, polyimide adhesives, polyamide adhesives, polyurethane adhesives, and silicone adhesives.

14. The aerostat of claim 9 wherein the aerostat has an internal volume of less than about 2000 cubic centimeters.

15. The aerostat of claim 9 wherein the self-mating adhesive layer has a seal strength of greater than about 2000 grams per inch.

16. A method of making an aerostat from a continuous web, comprising:
(a) unwinding a first barrier film having a first film inner side and a first film outer side from a first continuous roll;
(b) unwinding a second barrier film having a second film inner side and a second film outer side from a second continuous roll;
(c) printing a first adhesive precursor on the first film inner side;
(d) printing a second adhesive precursor on the second film inner side;
(e) laminating the first barrier film and the second barrier film together such that at least a portion of the first adhesive precursor printed on the first film inner side is in contact with at least a portion of the second adhesive precursor printed on the second film inner side;
(f) die cutting the first barrier film and the second barrier film to form an outer edge of the aerostat; and
(g) removing the aerostat from the continuous web.

17. The method of claim 16, further comprising irradiating the first barrier film and the second barrier film at the location where the first adhesive precursor is in contact with the second adhesive precursor, to form a self-mating adhesive layer binding the first barrier film to the second barrier film, after laminating the first barrier film and the second barrier film together.

18. The method of claim 17 wherein the self-mating adhesive layer comprises an adhesive selected from the group consisting of epoxy, polyester adhesives, polyimide adhesives, polyamide adhesives, polyurethane adhesives, and silicone adhesives.

19. The method of claim 16 wherein the first adhesive precursor comprises a resin and the second adhesive precursor comprises a curing agent.

20. The method of claim 16 wherein the first adhesive precursor comprises a monomer and the second adhesive precursor comprises a catalyst.
